(19) United States
(12) Patent Application Publication
(10) Pub. No.: US 2018/0218134 A1
(43) Pub. Date: Aug. 2, 2018

(54) DETERMINING COMPUTER OWNERSHIP

(71) Applicant: Microsoft Technology Licensing, LLC, Redmond, WA (US)

(72) Inventors: Tal Arieh Be'ery, Petach Tikva (IL); Igal Gofman, Bat Yam (IL); Marina Simakov, Ashdod (IL); Itai Grady, Ramat Hasharon (IL); Gil David, Zichron Yaakov (IL)

(73) Assignee: Microsoft Technology Licensing, LLC, Redmond, WA (US)

(21) Appl. No.: 15/607,458

(22) Filed: May 27, 2017

Related U.S. Application Data
(60) Provisional application No. 62/451,546, filed on Jan. 27, 2017.

(51) Int. Cl. G06F 21/31; G06F 17/30

(52) U.S. Cl. CPC G06F 21/31; G06F 17/30985

(57) ABSTRACT

The present disclosure is directed to systems, methods and devices for determining computer ownership in a distributed computer network associated with a directory service. Username similarity between username textual attributes and a computer's associated account management name may be determined. Network traffic information and event logs may be analyzed and determinations regarding local behavior and user behavior relating to a plurality of computers on a distributed computer network may be made. Local user data and an owner candidate list may be generated therefrom. Directory service data, including ownership attributes, may be analyzed to determine whether a user is the owner of a computer.

### CROSS-REFERENCE TO RELATED APPLICATIONS

This application claims the benefit of U.S. Provisional Application Ser. No. 62/451,546, filed Jan. 27, 2017, the complete disclosure of which is hereby incorporated by reference in its entirety.

### BACKGROUND

Establishing an owner relationship between a user and a computer is a desired feature in the context of internal network management and security. For example, a computer owner may be allowed by policy, or expected by a machine learning algorithm, to make certain actions to the computer that non-owners are not allowed or expected to do.

Additionally, although relatively specific problems are discussed, it should be understood that the aspects should not be limited to solving only the specific problems identified in the background.

### SUMMARY

This summary is provided to introduce a selection of concepts in a simplified form that are further described below in the Detailed Description section. This summary is not intended to identify key features or essential feature of the claimed subject matter, nor is it intended to be used as an aid in determining the scope of the claimed subject matter.

Non-limiting examples of the present disclosure describe systems, methods and devices for determining the ownership of one or more computing devices in a distributed computer network associated with a directory service. According to aspects, one or more ownership operations may be performed. The one or more ownership operations may be selected from a first ownership operation that includes extracting, for a plurality of users, a plurality of username textual attributes; determining, from the plurality of extracted username textual attributes, a username textual attribute sharing a longest common substring with an account management name associated with a first computing device in the distributed computer network; and calculating a character length overlap value between the identified username textual attribute and the account management name. A second ownership operation includes determining, for a plurality of computing devices in the distributed computer network, an identity of each of a plurality of users that has initiated an interactive login for one or more of the plurality of computing devices; calculating a percentage of interactive login initiations for the first computing device that were attempted by a specific user compared to interactive login initiations for the first computing device that were attempted by other users; and calculating a percentage of interactive login initiations for the first computing device that were attempted by the specific user compared to interactive login initiations for the plurality of computing devices that were attempted by the specific user. A third ownership operation may include determining a number of candidate computing devices of the plurality of computing devices that a SID for the specific user is associated with; and calculating a percentage of candidate computing devices of the plurality of computing devices that the SID for the specific user is associated with. A fourth ownership operation may include identifying an owner attribute associated with the first computing device and determining whether the owner attribute identifies the specific user as an owner of the first computing device; and calculating, based on performing the one or more ownership operations, a confidence score for assessing the likelihood that the specific user is the owner of the first computing device.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

FIG. 1 illustrates an example operating environment for determining computer ownership in a distributed computer network.

FIG. 2 is a flow chart showing general stages involved in an example method for determining computer ownership in a distributed computer network through performance of user name similarity operations.

FIG. 3 is a flow chart showing general stages involved in an example method for determining computer ownership in a distributed computer network through performance of traffic ownership operations.

FIG. 4 is a flow chart showing general stages involved in an example method for determining computer ownership in a distributed computer network through performance of local user data operations.

FIG. 5 is a continuation of the flow chart illustrated in FIG. 4.

FIGS. 6 and 7 are simplified block diagrams of a mobile computing device with which aspects of the disclosure may be practiced.

FIG. 8 is a block diagram illustrating example physical components of a computing device with which aspects of the disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Generally, the present disclosure is directed to systems, methods and devices for determining computer ownership in a distributed computer network. For example, it is typical for businesses and other entities that distribute computers to their members (e.g., employees) to register and connect those computers to an associated entity network. By registering computers to such a network, information regarding the user the device is associated with (as well as the device itself) may be collected in a directory service, such as ACTIVE DIRECTORY, provided by MICROSOFT CORPORATION. The directory service may include a domain controller for authenticating and authorizing all such users and computers in a domain type network, as well as assigning and enforcing security policies for all computers associated with the network and for installing or updating software.

Directory services generally store information regarding structural components of an entity in the form of objects. Objects may represent either resources e.g., printers) associated with a distributed computer network, or security principals (user or computer accounts and groups) associated with a distributed computer network. Security principals are assigned unique security identifiers (SIDs), which identify a user, a user group, or other security principal, as well as all properties of the principal, including its name.

Various permissions may be granted, either locally (at the user-computer level) or by a directory service and its corresponding domain controller, based on the credentials of a user. For example, a local user is one whose username and password are stored on the computer itself. When a user logs onto a computer as a local user, the computer checks its own list of users and its own password file to authenticate the logon, and upon authenticating the user, the computer itself then applies all permissions (e.g., “can use the CD-ROM”, “can install new programs”) and restrictions (e.g., “cannot install programs”) that are assigned to the user based on the local user credentials.

Alternatively, a domain user is one whose username and password are stored on a domain controller rather than the computer the user is logging into. When a user logs in as a domain user, the computer asks the domain controller what privileges are assigned to the user, and when the computer receives an appropriate response from the domain controller, it logs the user in with the corresponding permissions and restrictions associated with the user's credentials. In this manner, an entity can more readily ensure that only authorized users and devices are capable of taking certain actions within the entity's distributed computer network.

In the case that suspicious or malicious activity by an entity computer is detected on the entity's distributed computer network, it is useful to identify the computer's owner. For example, if the computer's owner is known, that owner may be contacted by an administrator to determine whether they took the action on the computer that lead to a suspicious or malicious behavior alert, or whether the user's computer or some other component of the entity's distributed computer network may have been hacked or otherwise tampered with. Thus, aspects of the present disclosure are directed to identifying the owner of a computer in a distributed computer network.

Accordingly, aspects of the disclosure relate to systems, methods, and devices for determining computer ownership in a distributed computer network. According to examples, one or more ownership operations may be performed to identify whether a specific user is the owner of a computer in a distributed computer network.

According to one example, a first ownership operation may be performed. The first ownership operation includes extracting, for a plurality of users, a plurality of username textual attributes; determining, from a plurality of extracted username textual attributes, a username textual attribute sharing a longest common substring with an account management name associated with a first computing device in the distributed computer network; and calculating a character length overlap value between the identified username textual attribute and the account management name. According to aspects, the account management name may be retrieved utilizing a protocol such as the Security Account Manager (SAM) Remote Protocol [MS-SAMR]) from MICROSOFT CORPORATION to retrieve various local information items such as local users on each machine, local group memberships and account management names for each computing device/machine in the network (e.g., SAM names).

According to another example, a second ownership operation may be performed. The second ownership operation includes determining, for a plurality of computing devices in a distributed computer network, an identity of each of a plurality of users that has initiated an interactive login for one or more of the plurality of computing devices; calculating a percentage of interactive login initiations for the first computing device that were attempted by a specific user compared to interactive login initiations for the first computing device that were attempted by other users; and calculating a percentage of interactive login initiations for the first computing device that were attempted by the specific user compared to interactive login initiations for the plurality of computing devices that were attempted by the specific user.

According to yet another example, a third ownership operation may be performed. The third ownership operation includes determining a number of candidate computing devices of a plurality of computing devices that a SID for a specific user is associated with; and calculating a percentage of candidate computing devices of the plurality of computing devices that the SID for the specific user is associated with.

In another example, a fourth ownership operation may be performed. The fourth ownership operation includes identifying an owner attribute associated with a first computing device, and determining whether the owner attribute identifies a specific user as an owner of the first computing device. For example, when a directory service object is created, one of the populated attributes is the “owner” attribute, which reflects the user which was used to create the object. In some cases, the value stored in this attribute represents a group rather than a user. For example, if the user is created by an account which is a member of the Domain Admins group or the Local Administrator group, then the owner of the object will be the corresponding group. If the owner is a user, rather than a group account, this information may be utilized in determining the identity of the computer owner. For example, if the user account is a Helpdesk/IT user which has been used to create objects for other computers, this object is not useful in determining whether the user is an owner. If such an account has not been used to create objects for other computers, it is indicative of the user being the computer's owner, and this fourth ownership operation, alone or in combination with additional ownership operations discussed herein, may be used in determining that the user is the computer's owner.

According to examples, each of the one or more ownership operations that are performed may be assigned an individual rank value for assessing whether a user is an owner of a specific computer. These values may be combined, in the case that more than one computer ownership operation is performed, into an overall confidence score for assessing the likelihood that the user is the owner of the specific computer. Calculations for the rank values, and ultimately the overall confidence score, may differentiate based on various criteria within a specific entity's distributed computer network, such as the size of the network, the number of group and local accounts associated with the network, the number of devices in a particular domain of the network, etc. Similarly, the calculations for the rank values, and ultimately the overall confidence score, may differentiate based on which of the one or more ownership operations are performed.

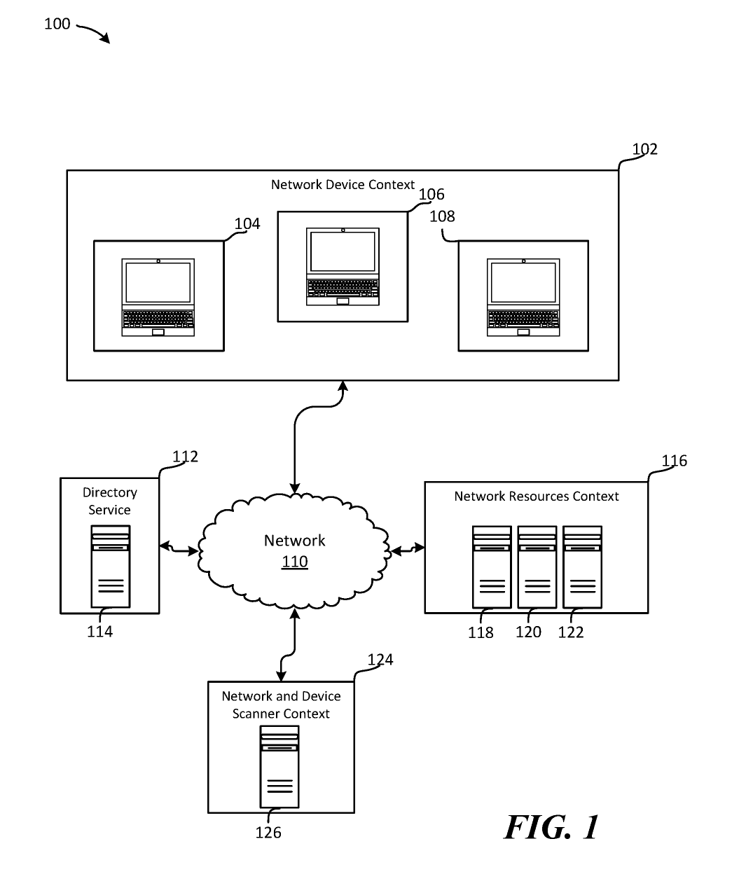

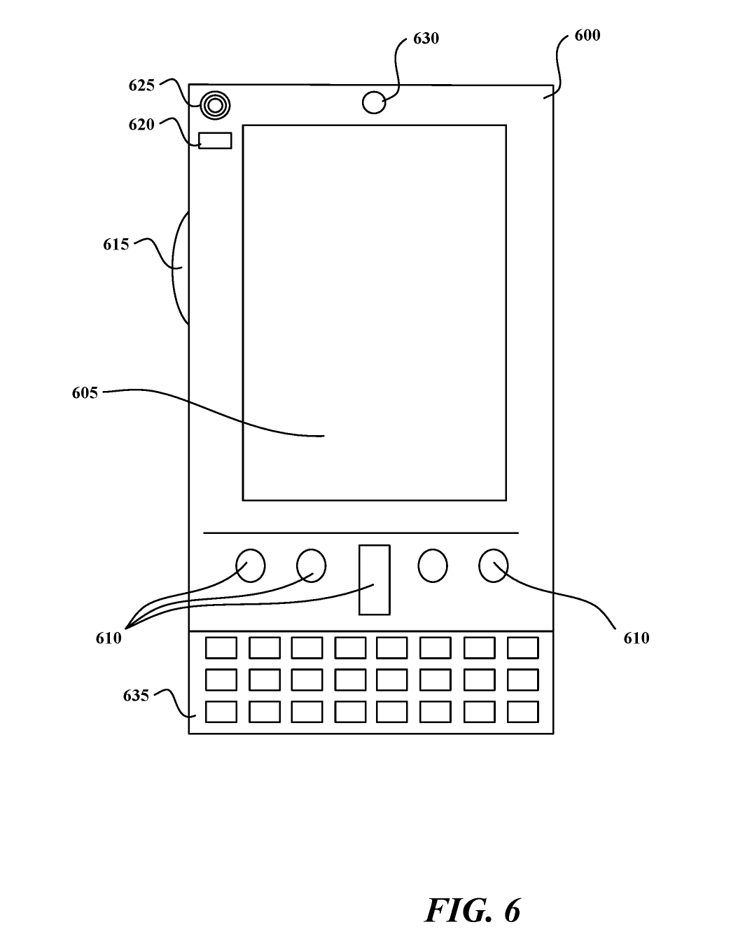

FIG. 1 illustrates an example operating environment 100 for determining computer ownership in a distributed computer network. Environment 100 includes network device context 102, network 110, directory service 112, network resources context 116, and network and device scanner context 124. The devices and systems illustrated in FIG. 1 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIGS. 6-10.

Network device context 102 includes computing devices 104, 106 and 108, each of which may belong to individual members of an entity. The computing devices 104, 106 and 108 may be associated with the entity via a directory service, such as directory service 112, which includes one or more server computing devices, such as server computing device 114. Computing devices 104, 106, and 108 may connect to directory service 112 and an associated domain controller for the entity via network 110. The directory service 112 may store name and credential information for each of the users associated with computing devices 104, 106 and 108, such that they may be granted appropriate access and permissions according to their authentication credentials as set by an administrator of the directory service 112.

The permissions associated with authentication credentials may be associated with the ability of users to access various entity resources (e.g., printers) connected with the entity's distributed computer network, as well as the ability of users to access certain local and virtual applications and/or update or add new software to their associated computing device. Network resources and virtual applications that may be accessible to a user, based on the domain controller authentication, may be accessed and/or managed via one or more computing devices such as server computing devices 118, 120, and 122 in network resources context 116.

Network and device scanner context 124 includes a scanning computing device and/or program (“the scanner”), which may reside on a computing device such as server computing device 126. The scanner may communicate with any of the computing devices included in environment 100. For example, the scanner may access local information, such as local user and administrator information, on any of computing devices 104, 106 and 108. The scanner may access domain information, such as domain user and administrator information, as well as traffic data and event log data, which includes logon and logoff information associated with user credentials and associated user computing devices. Additionally, the scanner may determine which resources and applications in network resource context 116 have been accessed by user devices and associated user credentials.

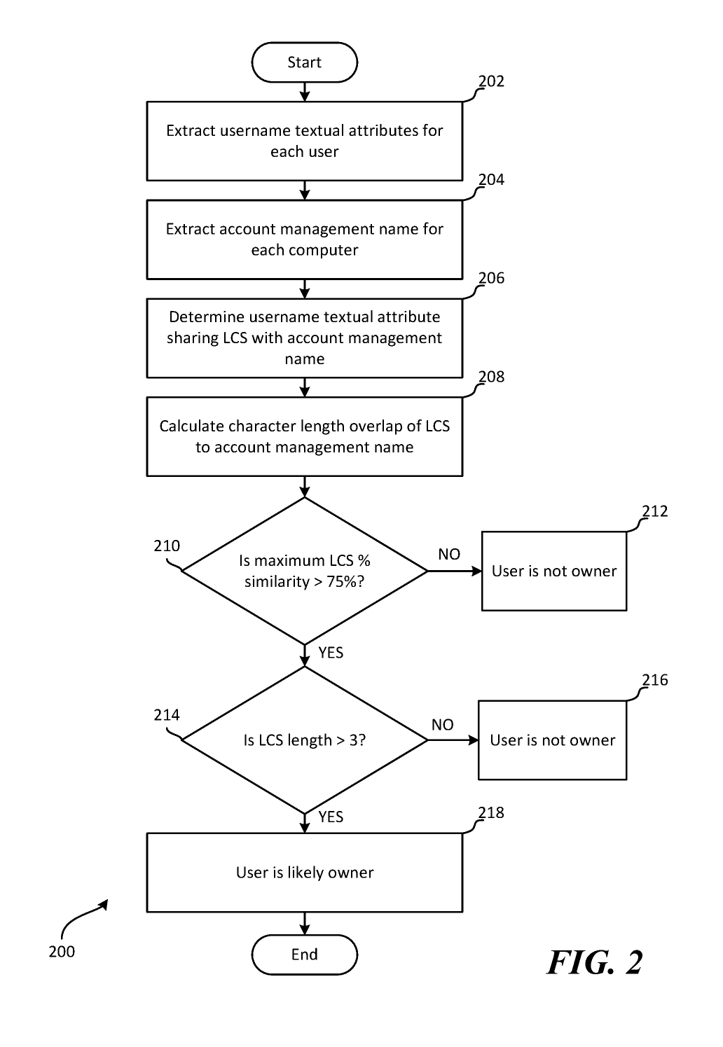

FIG. 2 is a flow chart showing general stages involved in an example method 200 for determining computer ownership in a distributed computer network through performance of user name similarity operations. The method 200 is based on the similarity between the machine and user names (e.g., in many cases, machine names are generated based on the user it belongs to).

The method 200 begins at a start operation and continues to operation 202 where one or more textual name fields for each user associated with an entity's distributed computer network may be extracted. According to examples, a network scanner may access a directory service associated with the entity's distributed computer network and extract user textual name fields including: first name, last name, display name and account management name (e.g., a SAM name) for the associated machine/computing device.

From operation 202, flow continues to operation 204 where an account management name may be extracted for each computer of the entity's distributed computer network, or alternatively, an account management name associated with a designated sub-group of computers (e.g., one or more specific domains) within the entity's distributed computer network, may be extracted. The account management names may be extracted by the same network scanner or a different network scanner as the network scanner that was utilized in operation 202 to extract user textual name fields.

From operation 204, flow continues to operation 206 where the username textual attributes extracted at operation 202 are analyzed against the computer account management names extracted at operation 204, and a determination is made as to the username textual attribute that has the longest common substring (LCS) that is shared with each computer's account management name. According to examples, natural language processing may be implemented in performing a match analysis of the username textual attributes and the account management names.

From operation 206, flow continues to operation 208 where a calculation is made as to the character length overlap of each LCS compared with each extracted account management name. According to other examples, natural language processing may be implemented in determining a match analysis of each LCS compared with each extracted account management name. For example, although there may not be a high degree of character overlap between an LCS and an account management name, a determination may nonetheless be made that the LCS and account management name are similar based on performance of the natural language processing. According to additional examples an LCS similarity percentage may be calculated at operation 208. That is, the LCS may be divided by the user textual field length (for example, length of LCS of first name and computer account management name, divided by length of first name).

From operation 208, flow continues to operation 210 where a determination is made as to whether an LCS similarity percentage exceeds a threshold value, such as 75%. If a determination is made at operation 210 that the LCS similarity percentage does not exceed the threshold value, flow continues to operation 212 and a determination is made that the user associated with the LCS is not the owner of the computing device that the corresponding account management name was extracted from, and the method 200 ends. Alternatively, if a determination is made at operation 210 that the LCS similarity percentage does exceed the threshold value, flow continues to operation 214.

At operation 212, a determination is made as to whether the LCS length is greater than a threshold number, such as three characters. If a determination is made at operation 212 that the LCS length is not greater than the threshold number, flow continues to operation 216 and a determination is made that the user associated with the LCS is not the owner of the computing device that the corresponding account management name was extracted from, and the method 200 ends. Alternatively, if a determination is made at operation 212 that the LCS length is greater than the threshold number, flow continues to operation 218 and a determination is made that the user associated with the LCS is the owner of the computing device that the corresponding account management name was extracted from, and the method 200 ends.

From operation 218, flow continues to an end operation and the method 200 ends.

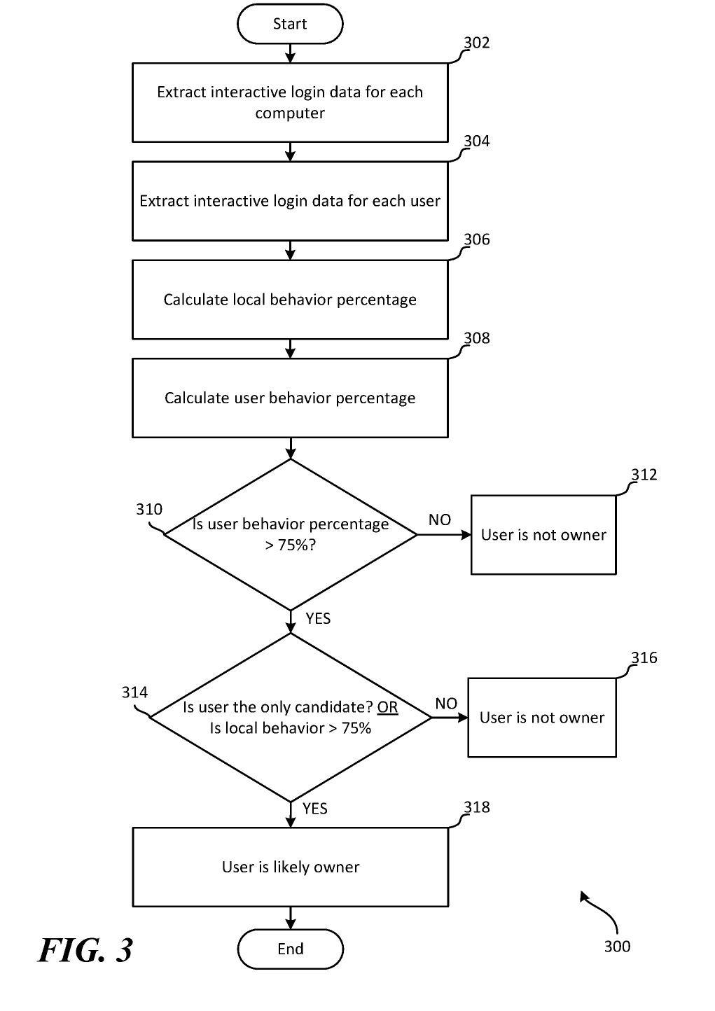

FIG. 3 is a flow chart showing general stages involved in an example method 300 for determining computer ownership in a distributed computer network through performance of traffic ownership operations. The method 300 utilizes traffic analysis from each user computing device, to get information regarding log-on patterns of users to domain machines. That is, it is more likely that a computing device is owned by a user if the user most frequently logs on to that computing device as compared to other computing devices associated with an entity's distributed computer network.

The method 300 begins at a start operation and continues to operation 302 where interactive login data for each computer is extracted (i.e., each instance of user-initiated login on a computer associated with an entity's distributed computer network is extracted from network traffic).

From operation 302, flow continues to operation 304 where interactive login data for each user is extracted. That is, network traffic is analyzed to determine all of the computers that each user interactively logged on to within the entity's distributed computer network. Using the data extracted at operations 302 and 304, a list of candidate owners for each computer may be generated which includes each user that has logged onto each computer.

From operation 304, flow continues to operation 306 where a local behavior percentage is calculated for each computer in the entity's distributed computer network. The local behavior percentage is the percentage of logins by a candidate user to a specific computer out of the rest of the logins of the other candidate users to that specific computer.

From operation 306, flow continues to operation 308 where a user behavior percentage is calculated. The user behavior percentage is a percentage of the number of logins by a candidate user to a specific computer compared to that user's logins to other computers associated with the entity's distributed computer network.

From operation 308, flow continues to operation 310 where a determination is made as to whether the user behavior percentage calculated at operation 308 exceeds a threshold value, such as 75%. If a determination is made at operation 310 that the user behavior percentage does not exceed the threshold value, flow continues to operation 312 and a determination is made that the user is not the owner of the computer. Alternatively, if a determination is made at operation 310 that the user behavior percentage does exceed the threshold value, flow continues to operation 314.

At operation 314, a first determination is made as to whether a specific candidate user is the only candidate user for the computer, and a second determination is made as to whether the local behavior percentage calculated at operation 306 exceeds a threshold value, such as 75%. If a determination is made at operation 314 that the specific candidate user is the only candidate user for the computer, flow continues to operation 318 and a determination is made that the user is likely the owner of the computer. If a determination is made at operation 314 that the local behavior percentage calculated at operation 306 exceeds the threshold value, flow also continues to operation 318 and a determination is made that the user is likely the owner of the computer. If at operation 314, a determination is made that the specific candidate user is not the only candidate user for the computer, and a determination is made that the local behavior percentage calculated at operation 306 does not exceed the threshold value, flow continues to operation 316 and a determination is made that the user is not the owner of the computer.

From operation 318, flow continues to an end operation and the method 200 ends.

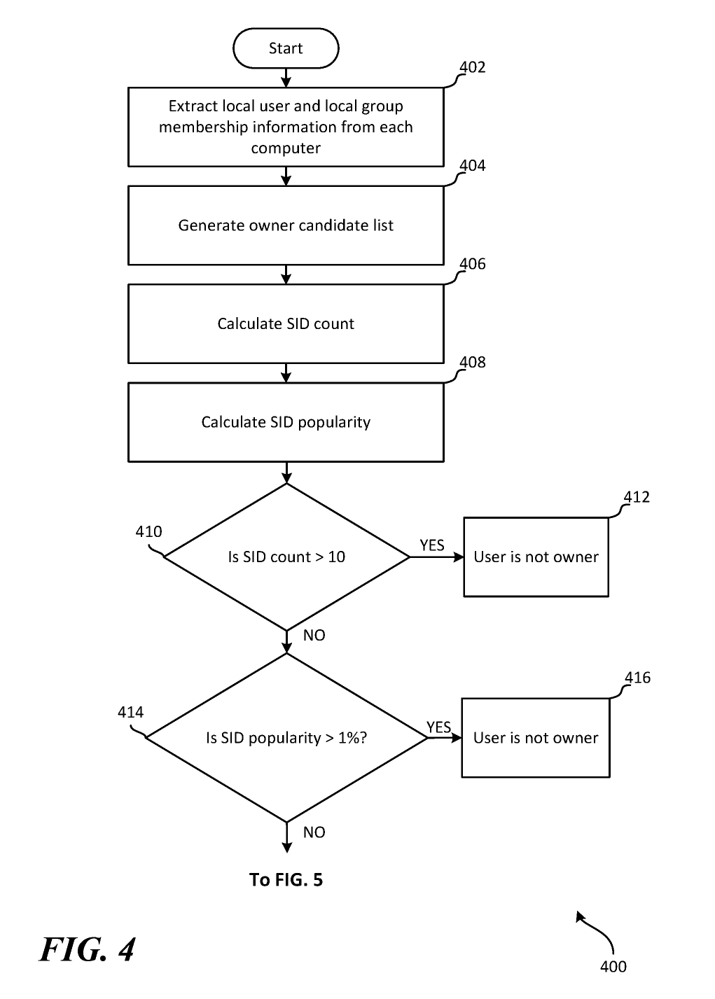

FIG. 4 is a flow chart showing general stages involved in an example method 400 for determining computer ownership in a distributed computer network through performance of local user data operations. According to examples, in method 400 each computing device associated with an entity's distributed computer network may be scanned (e.g., using a protocol such as the Security Account Manager (SAM) Remote Protocol [MS-SAMR]) from MICROSOFT CORPORATION to retrieve the following local information: local users on each machine and local group memberships. Additionally or alternatively this information may be determined through SID analysis and/or comparative analysis of user information from each computer to a domain directory of a network directory service. The results may then be analyzed to find the user which is most likely to be the owner of a specific machine.

The method 400 begins at a start operation and continues to operation 402 where local user and local group membership information is extracted from each computer associated with an entity's distributed computer network.

From operation 402, flow continues to operation 404 where a candidate list of potential owners is generated for each computer based on the local account information extracted at operation 402. The candidate list of potential owners for each computer includes each user that is associated with local account information for which the following are true: the account is not a local user on the machine, and the account belongs to the local Administrators group. The identification of local users and accounts belonging to the local Administrators group to generate the candidate list may be accomplished by scanning each computer, and extracting the local user and group membership information associated with each of those computers. Additionally or alternatively this information may be determined through SID analysis and/or comparative analysis of user information from each computer to a domain directory of a network directory service.

From operation 404, flow continues to operation 406 where a SID count is calculated for each candidate owner. That is, a calculation is made as to the number of distinct computers within the entity's distributed computer network that a candidate owner's SID was found locally on.

From operation 406, flow continues to operation 408 where SID popularity is calculated for each candidate owner. That is, a calculation is made as to the percentage computers in the entity's distributed computer network that a candidate owner's SID was found locally on (the SID count) compared to the total number of computers that were scanned.

From operation 408, flow continues to operation 410 where a determination is made as to whether the SID count calculated at operation 406 exceeds a threshold number. For example, the threshold SID count number may be ten. If a determination is made at operation 410 that the SID count number does exceed the threshold number, flow continues to operation 412 and a determination is made that the candidate owner associated with that SID count is not the owner of the computer. Alternatively, if a determination is made at operation 410 that the SID count does not exceed the threshold number, flow continues to operation 414.

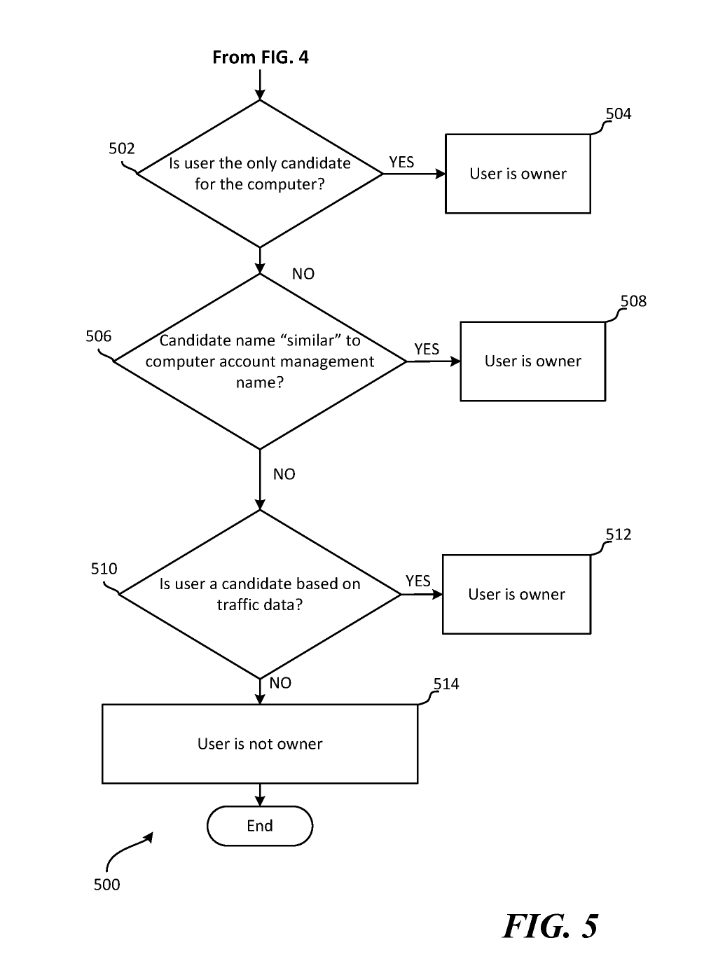

At operation 414, a determination is made as to whether the SID popularity percentage calculated at operation 408 exceeds a threshold value, such as 1%. If a determination is made at operation 414 that the SID popularity percentage does exceed the threshold value, flow continues to operation 416 and a determination is made that the candidate owner associated with the SID popularity is not the owner of the computer. Alternatively, if a determination is made at operation 414 that the SID popularity percentage does not exceed the threshold value, flow continues to FIG. 5, which is a continuation of the method 400.

Referring now to FIG. 5, at operation 502, a determination is made as to whether the user (i.e., the candidate owner) is the only candidate owner for the computer. That is, a determination is made as to whether there were any other candidate owners for the computer on the candidate list that was generated at operation 404. If a determination is made at operation 502 that the user is the only candidate owner for the computer, flow continues to operation 504 and a determination is made the user is the owner. Alternatively, if a determination is made at operation 502 that the user is not the only candidate owner for the computer, flow continues to operation 506.

At operation 506, a determination is made as to whether the user's candidate name (i.e., extracted username textual attributes for the user) is similar to the computer's account management name as discussed above with regard to FIG. 2. If a determination is made at operation 506 that the user's candidate name is similar to the computer's account management name, flow continues to operation 508 and a determination is made that the user is the owner. Alternatively, if a determination is made at operation 506 that the user's candidate name is not similar to the computer's account management name, flow continues to operation 510.

At operation 510, a determination is made as to whether the user is also a candidate based on the mechanisms discussed with regard to FIG. 4, and specifically operation 404. If a determination is made that the user is also a candidate based on the mechanisms discussed with regard to FIG. 4 at operation 404, flow continues to operation 512 and a determination is made that the user is the owner of the computer. Alternatively, if a determination is made that the user is not also a candidate based on the mechanisms discussed with regard to FIG. 4 at operation 404, flow continues to operation 514 and a determination is made that the user is not the computer's owner.

From operation 514, flow continues to and end operation and the method 500 ends.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 6-10 and the associated descriptions provide a discussion of a variety of operating environments in which examples are practiced. For example, a number of program modules and data files may are stored or otherwise are associated with the devices/systems illustrated in FIGS. 6-10 for performing various processes including, but not limited to, one or more of the stages of the methods 200, 300, 400 and 500 illustrated in FIGS. 2-5. However, the devices and systems illustrated and discussed with respect to FIGS. 6-10 are for purposes of example and illustration and are not limiting of a vast number of computing device configurations that are utilized for practicing aspects, described herein.

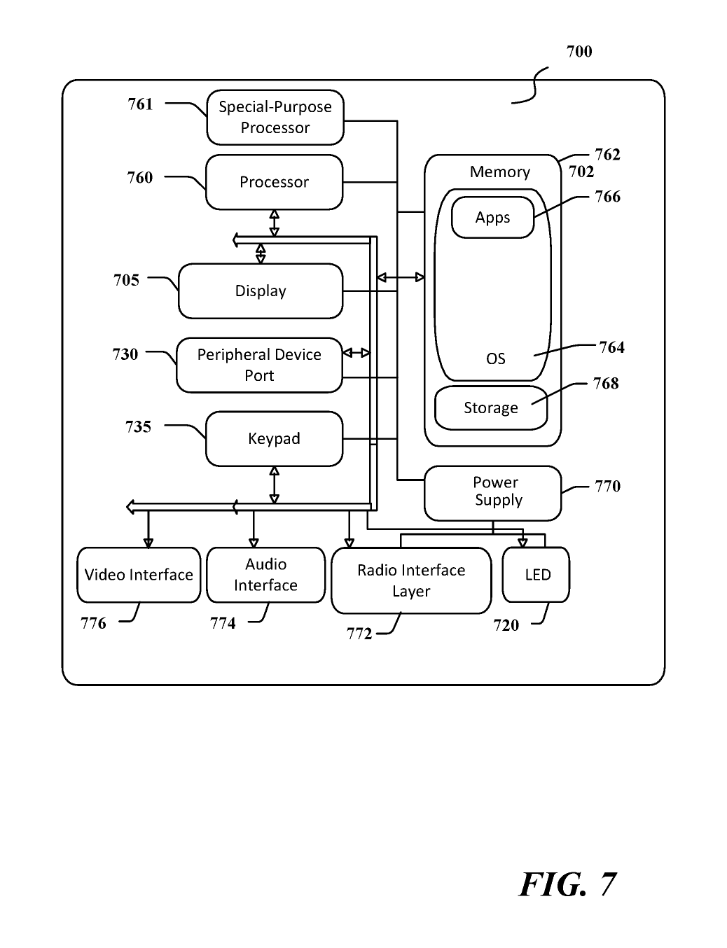

FIGS. 6 and 7 illustrate a mobile computing device 600, for example, a mobile telephone, a smart phone, wearable computer (such as a smart watch), a tablet computer, an e-reader, a laptop computer, and the like, with which embodiments of the disclosure may be practiced. In some aspects, the client may be a mobile computing device. With reference to FIG. 6, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 7 is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 864. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions for providing and operating a rules platform.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 620 may be used to provide visual notifications, and/or an audio interface 774 may be used for producing audible notifications via the audio transducer 625. In the illustrated embodiment, the visual indicator 620 is a light emitting diode (LED) and the audio transducer 625 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 625, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 630 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

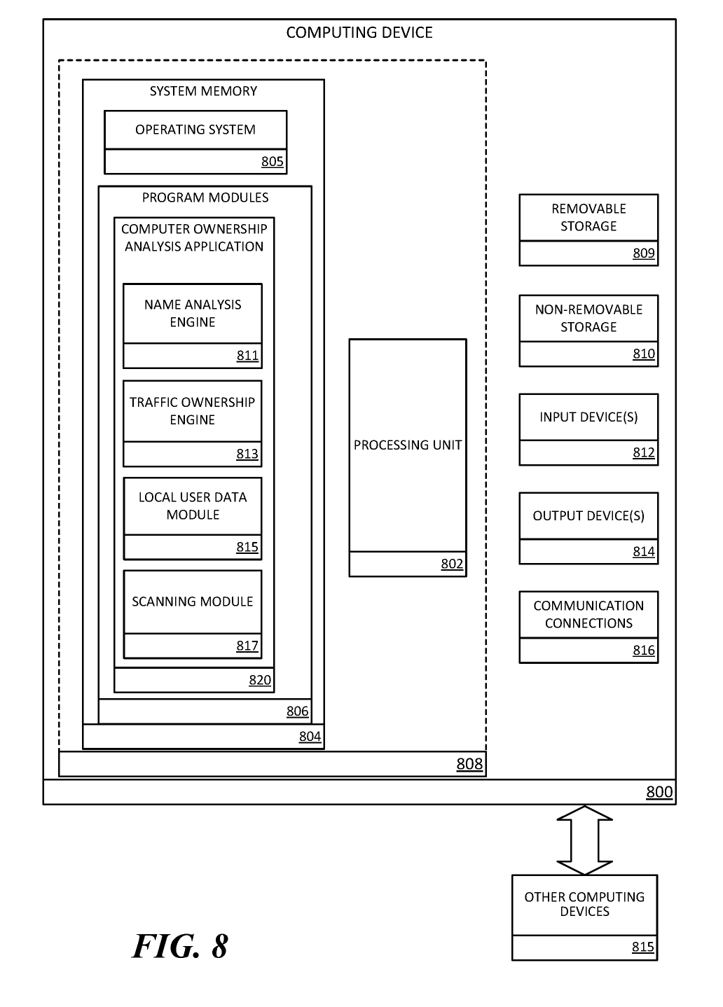

FIG. 8 is a block diagram illustrating physical components (e.g., hardware) of a computing device 800 with which aspects of the disclosure may be practiced. The computing device components described below may have computer executable instructions for assisting with determining computer ownership in a distributed computer network. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 suitable for running one or more computer ownership programs or one or more components in regards to FIG. 1. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., computer ownership analysis application 820) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 909, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

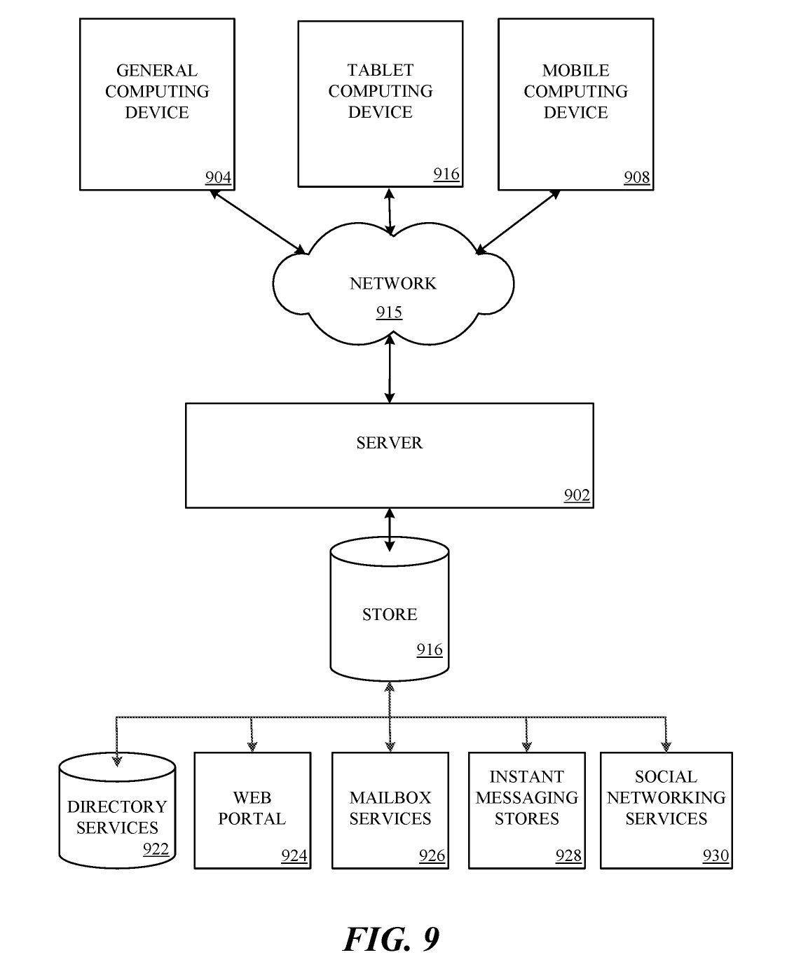

FIG. 9 illustrates one aspect of the architecture of a system for processing data received at a computing system from a remote source, such as a personal/general computer 904, tablet computing device 906, or mobile computing device 908, as described above. Content displayed at server device 902 may be stored in different communication channels or other storage types. For example, various documents may be stored using a directory service 112, 922, a web portal 924, a mailbox service 926, an instant messaging store 928, or a social networking site 930. The program modules 806 may be employed by a client that communicates with server device 902, and/or the program modules 806 may be employed by server device 902. The server device 902 may provide data to and from a client computing device such as a personal/general computer 904, a tablet computing device 906 and/or a mobile computing device 908 (e.g., a smart phone) through a network 915. By way of example, the computer system described above with respect to FIGS. 6-10 may be embodied in a personal/general computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

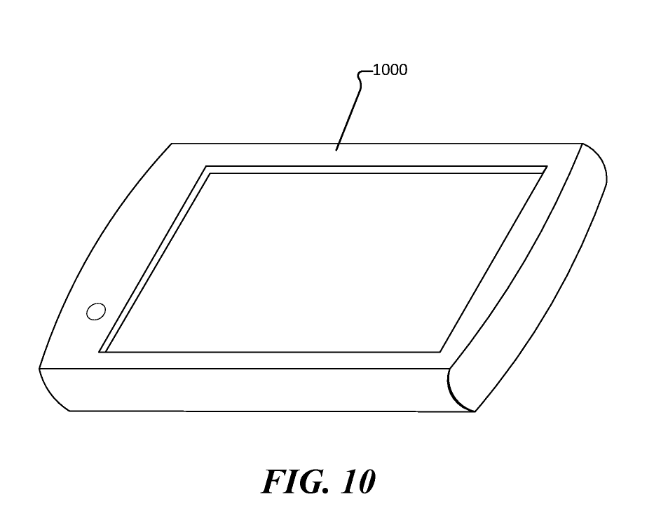

FIG. 10 illustrates an example tablet computing device 1000 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method for determining computer ownership in a distributed computer network, comprising:
extracting, for a plurality of users, a plurality of username textual attributes;
determining, from the plurality of extracted username textual attributes, a username textual attribute sharing a longest common substring with an account management name associated with a first computing device in the distributed computer network; and
calculating a character length overlap value between the identified username textual attribute and the account management name.

2. The method of claim 1, further comprising:
determining, for a plurality of computing devices in the distributed computer network, an identity of each of a plurality of users that has initiated an interactive login for one or more of the plurality of computing devices;
calculating a percentage of interactive login initiations for the first computing device that were attempted by a specific user compared to interactive login initiations for the first computing device that were attempted by other users; and
calculating a percentage of interactive login initiations for the first computing device that were attempted by the specific user compared to interactive login initiations for the plurality of computing devices that were attempted by the specific user.

3. The method of claim 1, further comprising:
determining a number of candidate computing devices of the plurality of computing devices that a SID for the specific user is associated with; and
calculating a percentage of candidate computing devices of the plurality of computing devices that the SID for the specific user is associated with.

4. The method of claim 1, further comprising:
identifying an owner attribute associated with the first computing device and determining whether the owner attribute identifies the specific user as an owner of the first computing device; and
calculating, based on performing the one or more ownership operations, a confidence score for assessing the likelihood that the specific user is the owner of the first computing device.

5. The method of claim 1, wherein each of the plurality of textual attributes are extracted from a directory service associated with the computing device.

6. The method of claim 1, wherein the plurality of username textual attributes are selected from: a first name, a last name, a display name, and an account management name.

7. The method of claim 1, wherein each of the plurality of computing devices in the distributed computer network are associated with a specific domain in a directory service.

8. The method of claim 3, further comprising:
scanning the plurality of computing devices in the distributed computing environment;
identifying at least one local user associated with each of the plurality of computing devices; and
excluding the at least one identified local user as a candidate owner.

9. The method of claim 8, wherein the third ownership operation further comprises:
scanning the plurality of computing devices in the distributed computing environment;
identifying at least one domain user associated with each of the plurality of computing devices; and
including the at least one identified local user as a candidate owner.

10. The method of claim 3, wherein the third ownership operation further comprises:
removing the specific user from a candidate list when the calculated percentage of candidate computing devices of the plurality of computing devices that the SID for the specific user is associated with exceeds a threshold value.

11. The method of claim 2, further comprising:
confirming that the specific user is an owner of the first computing device when:
the calculated percentage of interactive login initiations for the first computing device that were attempted by the specific user compared to interactive login initiations for the first computing device that were attempted by other users exceeds a local behavior threshold value; and
the calculated percentage of interactive login initiations for the first computing device that were attempted by the specific user compared to interactive login initiations for the plurality of computing devices that were attempted by the specific user exceeds a user behavior threshold value.

12. The method of claim 3, wherein the third ownership operation further comprises:
removing the specific user from a candidate list when the SID for the specific user is associated with a threshold number of the plurality of computing devices.

13. The method of claim 1, further comprising:
confirming that a user associated with the identified username textual attribute is an owner of the first computing device when:
the longest common substring exceeds three characters; and
the calculated character length overlap between the identified username textual attribute and the account management name exceeds a threshold value.

14. A system for determining computer ownership in a distributed computer network, comprising:
a memory for storing executable program code; and
a processor, functionally coupled to the memory, the processor being responsive to computer-executable instructions contained in the program code and operative to:
extract, for a plurality of users, a plurality of username textual attributes;
determine, from the plurality of extracted username textual attributes, a username textual attribute sharing a longest common substring with an account management name associated with a first computing device in the distributed computer network; and
calculate a character length overlap value between the identified username textual attribute and the account management name.

15. The system of claim 14, wherein the processor is further responsive to the computer-executable instructions contained in the program code and operative to:
determine, for a plurality of computing devices in the distributed computer network, an identity of each of a plurality of users that has initiated an interactive login for one or more of the plurality of computing devices;
calculate a percentage of interactive login initiations for the first computing device that were attempted by a specific user compared to interactive login initiations for the first computing device that were attempted by other users; and
calculate a percentage of interactive login initiations for the first computing device that were attempted by the specific user compared to interactive login initiations for the plurality of computing devices that were attempted by the specific user.

16. The system of claim 14, wherein the processor is further responsive to the computer-executable instructions contained in the program code and operative to:
determine a number of candidate computing devices of the plurality of computing devices that a SID for the specific user is associated with; and
calculate a percentage of candidate computing devices of the plurality of computing devices that the SID for the specific user is associated with.

17. The system of claim 14, wherein the processor is further responsive to the computer-executable instructions contained in the program code and operative to:
identify an owner attribute associated with the first computing device and determining whether the owner attribute identifies the specific user as an owner of the first computing device; and
calculate, based on performing the one or more ownership operations, a confidence score for assessing the likelihood that the specific user is the owner of the first computing device.

18. A computer-readable storage device comprising executable instructions, that when executed by a processor, assist with determining computer ownership in a distributed computer network, the computer-readable storage device including instructions executable by the processor for:
determining, for a plurality of computing devices in the distributed computer network, an identity of each of a plurality of users that has initiated an interactive login for one or more of the plurality of computing devices;
calculating a percentage of interactive login initiations for the first computing device that were attempted by a specific user compared to interactive login initiations for the first computing device that were attempted by other users; and
calculating a percentage of interactive login initiations for the first computing device that were attempted by the specific user compared to interactive login initiations for the plurality of computing devices that were attempted by the specific user.

19. The computer-readable storage device of claim 18, wherein the instructions are further executable by the processor for:
extracting, for a plurality of users, a plurality of username textual attributes;
determining, from the plurality of extracted username textual attributes, a username textual attribute sharing a longest common substring with an account management name associated with a first computing device in the distributed computer network; and
calculating a character length overlap value between the identified username textual attribute and the account management name.

20. The computer-readable storage device of claim 18, wherein the instructions are further executable by the processor for:
confirming that the specific user is an owner of the first computing device when:
the calculated percentage of interactive login initiations for the first computing device that were attempted by the specific user compared to interactive login initiations for the first computing device that were attempted by other users exceeds a local behavior threshold value; and
the calculated percentage of interactive login initiations for the first computing device that were attempted by the specific user compared to interactive login initiations for the plurality of computing devices that were attempted by the specific user exceeds a user behavior threshold value.
